(19) United States
(12) Patent Application Publication
(10) Pub. No.: US 2026/0137242 A1
(43) Pub. Date: May 21, 2026

(54) Scoop Utensil Having Cylindrical Handle

(71) Applicant: Michael DeSantis, Selden, NY (US)

(72) Inventor: Michael DeSantis, Selden, NY (US)

(21) Appl. No.: 19/316,231

(22) Filed: Sep. 2, 2025

Related U.S. Application Data
(63) Continuation-in-part of application No. 29/973,370, filed on Nov. 15, 2024.

(51) Int. Cl. A47J 43/28

(52) U.S. Cl. CPC A47J 43/28

(57) ABSTRACT

A scoop utensil that can be used to pick up, move, and ultimately deposit a desired amount of a material, such as a granular or other flowing substance, into a discrete, target container. The scoop utensil disclosed herein may have a holding aspect defined by a cylindrical receptacle portion having an open top and a closed bottom, and a handling aspect defined by a cylindrical handle member that extends outwardly from the receptacle portion at a location that is between its open top and closed bottom. Embodiments of the receptacle portion may include a sidewall having a length that is at least twice the length of the diameter of the receptacle portion's open top. In this regard, the scoop utensil may be especially suited for dumping out the entire contents of the holding aspect into a narrow-mouthed container.

### CROSS REFERENCE TO RELATED APPLICATIONS

This application claims the benefit of and incorporates by reference co-pending U.S. non-provisional patent application Ser. No. 29/973,370, filed Nov. 15, 2024.

### BACKGROUND OF THE INVENTION

### Field of the Invention

This invention relates generally to scooping implements and, more particularly, to a scoop utensil structured to transfer a desired amount of a substance into a narrow-mouthed container.

### Description of the Prior Art

The use of scooping implements to pick up, move, and ultimately deposit a desired amount of a bulk substance into a discrete, target container is well established. Such scoping implements will commonly include a handling aspect and a holding aspect, as these components can serve to allow one to accomplish the ultimate purpose of manually transferring a substance. That said, different styles of scoping implements exist, each with varying structures and arrangements of the handling and holding aspects. Often, variations in the structure and arrangement of these handling and holding aspects relate to the nature of the substance the scooping implement is being used for.

Among the most common style of scooping implements is a scoop utensil for dry powder substances. Scoop utensils for dry powders often include a cylindrical, hemispherical, or conical holding aspect with a wide mouth, and a handling aspect defined by a flat handle that extends outwardly at or near the mouth of the holding aspect. Such a design may maximize the ease in which material can be gathered into and dumped out of the holding aspect, particularly as the positioning of its handling aspect provides substantial support to the mouth portion of the holding aspect when it is dug into and drug through the dry powder desired to be gathered into the holding aspect.

A problem that still exists, however, is that scoop utensils for dry powders typically struggle to dump out material gathered in its holding aspect directly into target containers that have a narrow mouth, like a conventional water bottle. For example, when the mouth of the holding aspect of such a conventional scoop utensil is wider than the mouth of the target container, it is nearly impossible to dump out the entire contents of the holding aspect into the target container, at least without some type of discrete funneling mechanism. Moreover, when its holding aspect is flat, rotating such a scoop utensil requires that a user rotate their entire hand and their arm from the elbow down, which introduces more instability to the rotational movement that would exist if rotation could be accomplished with moving less of the user's arm/hand.

Accordingly, there remains a need for a scoop utensil that has a cylindrical handle as its handling aspect so as to allow for its holding aspect to be rotated while only requiring that a user move two fingers. It would be desirable for such a scoop utensil having a cylindrical handle to have a holding aspect with a mouth that is narrower than the depth of said holding aspect. Further, it would be desirable for such a scoop utensil having a cylindrical handle to have a handling aspect that attaches to the holding aspect well below the mouth of the holding aspect.

### SUMMARY OF THE INVENTION

The present disclosure provides for a scoop utensil, comprising: an elongated receptacle portion having an open top, closed bottom, and at least one sidewall having a length and extending between the open top and the closed bottom, wherein the receptacle portion is cylindrical and the open top has a diameter; a cylindrical handle member integral with the receptacle portion, wherein the handle member extends outward from the at least one sidewall at a location between the open top and the closed bottom; and wherein the length of the at least one sidewall has a greater numerical value than the diameter.

It is an object of the present disclosure to provide a scoop utensil that has a cylindrical handle as its handling aspect so as to allow for its holding aspect to be rotated while only requiring that a user move two fingers.

It is an additional object of the present disclosure to provide a scoop utensil having a cylindrical handle that has a holding aspect with a mouth that is narrower than the depth of said holding aspect.

It is yet an additional object of the present disclosure to provide a scoop utensil having a cylindrical handle that has a handling aspect that attaches to the holding aspect well below the mouth of the holding aspect.

These and other objects will be apparent to one of skill in the art.

### BRIEF DESCRIPTION OF THE DRAWINGS

FIG. 1 is a top perspective view of a scoop utensil having a cylindrical handle built in accordance with an embodiment of the present disclosure, shown in a dumping orientation over a narrow-mouthed container.

FIG. 1A is a top perspective view of a scoop utensil having a cylindrical handle built in accordance with an embodiment of the present disclosure, shown in a dumping orientation over a narrow-mouthed container..

FIG. 2 is a top perspective view of a scoop utensil having a cylindrical handle built in accordance with an embodiment of the present disclosure, shown in an upright orientation.

FIG. 3 is a right side elevation view of a scoop utensil having a cylindrical handle built in accordance with an embodiment of the present disclosure, shown in an upright orientation.

FIG. 4 is a left side elevation view of a scoop utensil having a cylindrical handle built in accordance with an embodiment of the present disclosure, shown in an upright orientation.

FIG. 5 is a front elevation view of a scoop utensil having a cylindrical handle built in accordance with an embodiment of the present disclosure, shown in an upright orientation.

FIG. 6 is a rear elevation view of a scoop utensil having a cylindrical handle built in accordance with an embodiment of the present disclosure, shown in an upright orientation.

FIG. 7 is a top plan view of a scoop utensil having a cylindrical handle built in accordance with an embodiment of the present disclosure, shown in an upright orientation.

FIG. 8 is a bottom plan view of a scoop utensil having a cylindrical handle built in accordance with an embodiment of the present disclosure, shown in an upright orientation.

### DETAILED DESCRIPTION OF THE INVENTION

Described herein is a scoop utensil that can be used to pick up, move, and ultimately deposit a desired amount of a material, such as a granular or other flowing substance, into a discrete, target container. The scoop utensil disclosed herein may have a holding aspect defined by a cylindrical receptacle portion having an open top and a closed bottom and a handling aspect defined by a cylindrical handle member that extends outwardly from the receptacle portion at a location that is between its open top and closed bottom. Embodiments of the receptacle portion may include a sidewall having a length that is at least twice the length of the diameter of the receptacle portion's open top. In this regard, the scoop utensil may be especially suited for dumping out the entire contents of the holding aspect into a narrow-mouthed container.

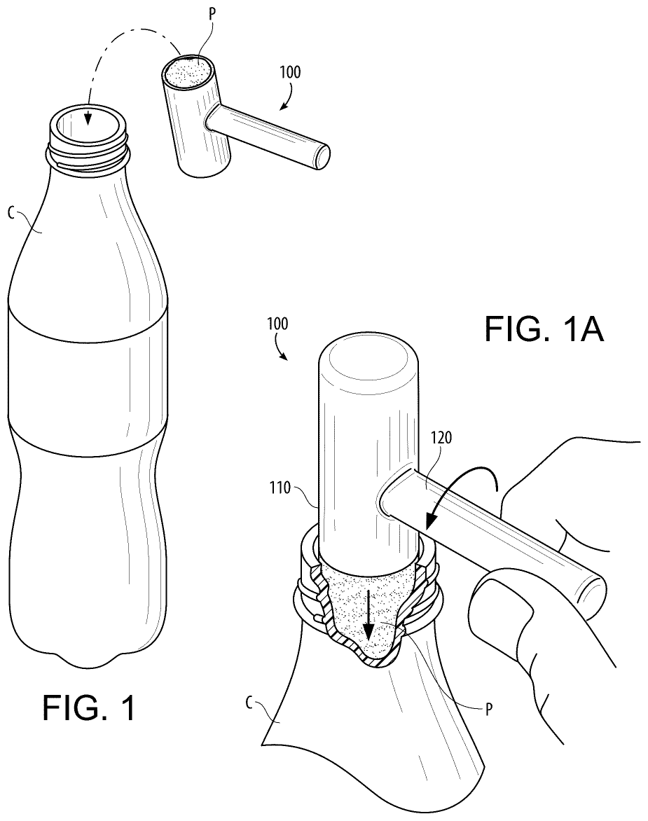

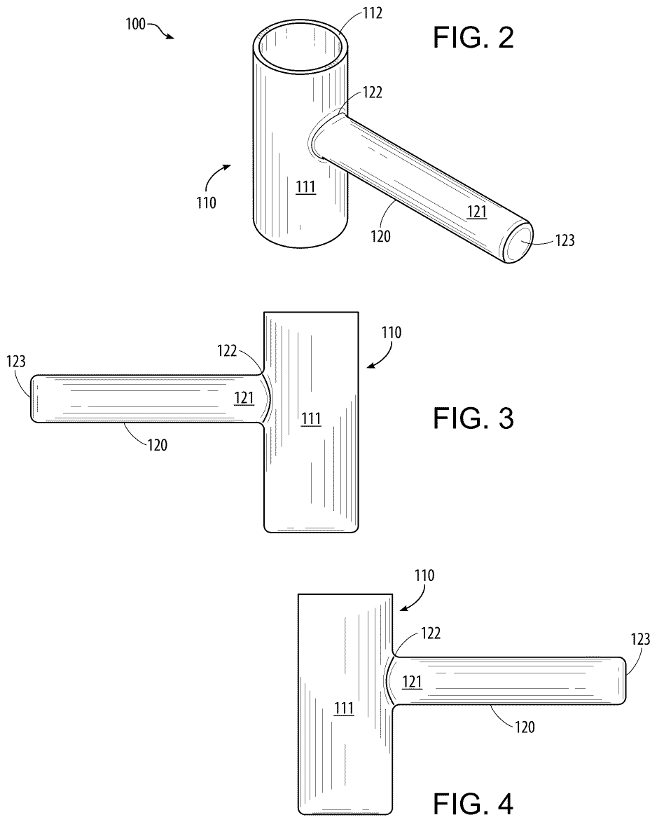

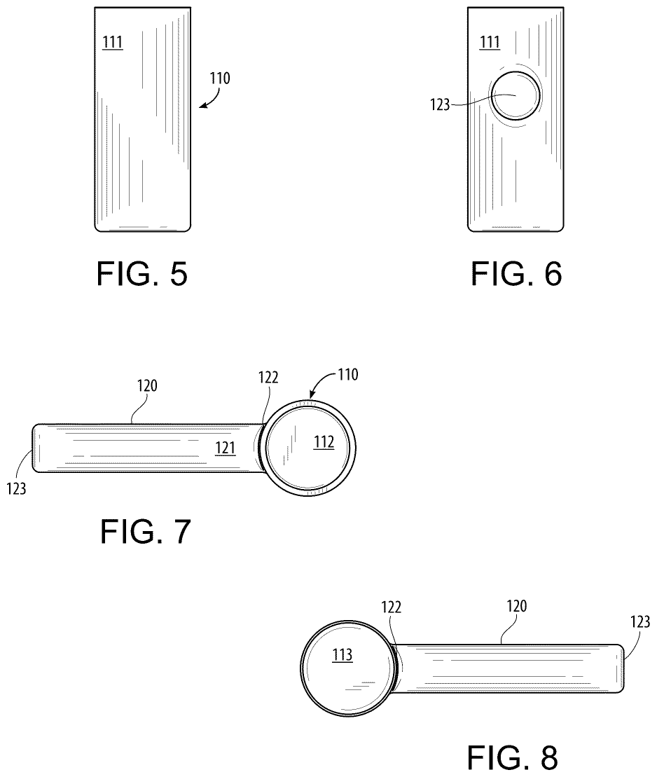

Referring now to the drawings and, in particular, FIGS. 1, 1A, 2, 3, 4, 5, 6, 7 and 8, a scoop utensil 100 built in accordance with the present invention is shown having a receptacle portion 110 and a handle member 120. The scoop utensil 100 may advantageously be employed to introduce a dry powdery or granular substance that is disposed in the receptacle portion 110 into a discrete container C, even in cases where the container C has a relatively narrow mouth, like many commercially sold 12-24 ounce plastic beverage bottles.

The receptacle portion 110 may be embodied as a rigid, cylindrical member having a smooth elongated sidewall 111, a circular open top 112 and a circular closed bottom 113. Embodiments of the receptacle portion 110 may be constructed of a hard, plastic material, such as polypropylene, or another rigid material such as stainless steel. The receptacle portion 110 may have a diameter of 0.75 inches with the elongated sidewall 111 being 1.75 inches in length. In this regard, the receptacle portion 110 may be proportioned as a relatively tall and narrow structure with its height/length being over twice as great as its diameter.

The handle member 120 may be embodied as a rigid, cylindrical body 121 that is elongated and has a proximal end 122 and an opposing distal end 123. The handle member 120 may be integrated with the receptacle portion 110 with the proximal end 122 coupled to the elongated sidewall 111 such that the body 121 extends outward from the sidewall 111 with the length of the body 121 orthogonal to the length of the sidewall 111. It is appreciated that such a relative orientation may operate to enable the handle member 120 to provide a structure that can be grasped by a user. Moreover, it is appreciated that the handle member's 120 cylindrical shape would allow for a user who is grasping the handle member 120 to rotate it while holding it between just two fingers, without having to move any other portion of their hand or arm.

Furthermore, the proximal end 122 may be coupled to the elongated sidewall 111 with 0.5 inches between the open top 112 and any portion of the body 121. Other embodiments may have the proximal end 122 coupled to the elongated sidewall 111 at a location that is greater or less than 0.5 inches between the open top 112 and any portion of the body 121, but always with greater than one-fourth the total length of the elongated sidewall 111 between the open top 112 and any portion of the body 121. It is appreciated that, through such relative positioning, the body 121 may be sufficiently spaced away from the open top 112 so as to allow the open top to be inserted into the mouth of containers that have a relatively narrow mouth, such as many commercially sold 12-24 ounce plastic beverage bottles.

Embodiments of the handle member 120 may be 1.25 inches in length between its proximal end 121 and distal end 122, and may be constructed of a hard, plastic material, such as polypropylene, or another rigid material, such as stainless steel.

In some embodiments of the scoop utensil 100, the receptacle portion 110 and handle member 120 may be formed from a single molded piece of plastic. In other embodiments, the receptacle portion 110 and handle member 120 may be formed separately and permanently attached to one another through conventional mechanisms like an adhesive or welding.

In alternate embodiments, the receptacle portion may have an open top having a polygonal profile, such as an open top that is rectangular. In such embodiments, the open top may have a diagonal dimension and the receptacle portion may be proportioned as a relatively tall and narrow structure with its height/length being over twice as great as its diagonal dimension.

In an alternate embodiment, the receptacle portion may have a circular open top, a circular closed bottom, and a smooth elongated sidewall, but with the diameter of the open top being larger than the diameter of the closed bottom. Through such a design, the receptacle portion would be tapered.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A scoop utensil, comprising:
an elongated receptacle portion having an open top, closed bottom, and at least one sidewall having a length and extending between the open top and the closed bottom, wherein the receptacle portion is cylindrical and the open top has a diameter;
a handle member integral with the receptacle portion, wherein the handle member extends outward from the at least one sidewall at a location between the open top and the closed bottom; and
wherein the length of the at least one sidewall has a greater numerical value than the diameter.

2. The scoop utensil of claim 1, wherein the handle member is cylindrical.

3. The scoop utensil of claim 2, wherein the length of the at least one sidewall has a numerical value that is greater than twice that of the diameter.

4. The scoop utensil of claim 2, wherein the length of the at least one sidewall has a numerical value that is greater than twice that of the diameter but less than three times that of the diameter.

5. The scoop utensil of claim 2, wherein the handle member extends outward from the at least one sidewall at a location that is greater than one-fourth the length of the sidewall from the open top.

6. The scoop utensil of claim 1, wherein the length of the at least one sidewall has a numerical value that is greater than twice that of the diameter.

7. The scoop utensil of claim 1, wherein the length of the at least one sidewall has a numerical value that is greater than twice that of the diameter but less than three times that of the diameter.

8. The scoop utensil of claim 1, wherein the handle member extends outward from the at least one sidewall at a location that is greater than one-fourth the length of the sidewall from the open top.

9. A scoop utensil, comprising:
an elongated receptacle portion having an open top, closed bottom, and at least one sidewall having a length and extending between the open top and the closed bottom, wherein the open top has at least one of a diameter and a diagonal dimension;
a handle member integral with the receptacle portion, wherein the handle member extends outward from the at least one sidewall at a location between the open top and the closed bottom; and
wherein the length of the at least one sidewall has a greater numerical value than the at least one of the diameter and the diagonal dimension.

10. The scoop utensil of claim 9, wherein the handle member is cylindrical.

11. The scoop utensil of claim 10, wherein the length of the at least one sidewall has a numerical value that is greater than twice that of the at least one of the diameter and the diagonal dimension.

12. The scoop utensil of claim 10, wherein the length of the at least one sidewall has a numerical value that is greater than twice that of the at least one of the diameter and the diagonal dimension but less than three times that of the at least one of the diameter and the diagonal dimension.

13. The scoop utensil of claim 10, wherein the handle member extends outward from the at least one sidewall at a location that is greater than one-fourth the length of the sidewall from the open top.

14. The scoop utensil of claim 9, wherein the length of the at least one sidewall has a numerical value that is greater than twice that of the at least one of the diameter and the diagonal dimension.

15. The scoop utensil of claim 9, wherein the length of the at least one sidewall has a numerical value that is greater than twice that of the at least one of the diameter and the diagonal dimension but less than three times that of the at least one of the diameter and the diagonal dimension.

16. The scoop utensil of claim 9, wherein the handle member extends outward from the at least one sidewall at a location that is greater than one-fourth the length of the sidewall from the open top.

17. A scoop utensil, comprising:
an elongated receptacle portion having an open top, closed bottom, and at least one sidewall having a length and extending between the open top and the closed bottom, wherein the receptacle portion is cylindrical and the open top has a diameter;
a handle member integral with the receptacle portion, wherein the handle member is cylindrical and extends outward from the at least one sidewall at a location between the open top and the closed bottom; and
wherein the length of the at least one sidewall has a numerical value that is greater than twice that of the diameter.

18. The scoop utensil of claim 17, wherein the length of the at least one sidewall has a numerical value that is greater than twice that of the diameter but less than three times that of the diameter.

19. The scoop utensil of claim 18, wherein the handle member extends outward from the at least one sidewall at a location that is greater than one-fourth the length of the sidewall from the open top.

20. The scoop utensil of claim 17, wherein the handle member extends outward from the at least one sidewall at a location that is greater than one-fourth the length of the sidewall from the open top.
